(19) United States
(12) Patent Application Publication
(10) Pub. No.: US 2026/0258879 A1
(43) Pub. Date: Sep. 3, 2026

(54) VALVE HOUSING AND A VALVE ASSEMBLY

(71) Applicants: HYUNDAI MOTOR COMPANY, Seoul (KR); KIA CORPORATION, Seoul (KR); HANON SYSTEMS, Daejeon (KR)

(72) Inventors: Jungbum Choi, Daejeon (KR); Gwang Ok Ko, Daejeon (KR); Hyun Woong Shin, Daejeon (KR); Shin-Won Yun, Daejeon (KR); Min Ho Jang, Daejeon (KR); Seong Woo Jeong, Daejeon (KR); Jeong Wan Han, Daejeon (KR); Dong Seok Oh, Hwaseong-si (KR); Jung Ha Park, Hwaseong-si (KR); Yong Woong Cha, Hwaseong-si (KR); Seong Bin Jeong, Hwaseong-si (KR); Eon Soo Yun, Hwaseong-si (KR)

(73) Assignees: HYUNDAI MOTOR COMPANY, Seoul (KR); KIA CORPORATION, Seoul (KR); HANON SYSTEMS, Daejeon (KR)

(21) Appl. No.: 19/410,804

(22) Filed: Dec. 5, 2025

(30) Foreign Application Priority Data
Feb. 28, 2025 (KR) 10-2025-0027019

(51) Int. Cl. F16K 27/06; F16K 11/085

(52) U.S. Cl. CPC F16K 27/065; F16K 11/0856

(57) ABSTRACT

A valve housing includes a housing body configured to accommodate a valve rotor and a channel block having a plurality of channels provided in the inside thereof. The housing body has a plurality of ports formed therein. Each of the ports is configured to communicate with a valve rotor. The channel block has at least one partition wall provided in the inside thereof. The partition wall is configured to partition the channel block into the plurality of channels and the channels are connected to the respective ports.

### CROSS-REFERENCE TO RELATED APPLICATION

This application claims, under 35 U.S.C. §119(a), the benefit of and priority to Korean Patent Application No. 10-2025-0027019, filed on Feb. 28, 2025, the entire contents of which are incorporated herein by reference.

### BACKGROUND

### (a) Technical Field

The present disclosure relates to a valve housing for fluid control and a valve assembly including the valve housing.

### (b) Background Art

Recently, environmental regulations have been strictly strengthened. Also, there has been increasing demand for sustainable vehicles such as electric vehicles (EVs) and hybrid electric vehicles (HEVs). Accordingly, the automobile industry is rapidly transitioning from internal combustion engine (ICE) vehicles to eco-friendly vehicles. Eco-friendly vehicles, such as electric vehicles (EVs), plug-in hybrid electric vehicles (PHEVs), and fuel cell electric vehicles (FCEVs), have been provided as key alternatives to reduce emission of carbon-containing gases into the atmosphere. Thus, research and development has been actively conducted on techniques related to eco-friendly vehicles. Such transition from ICE vehicles to eco-friendly vehicles affects a driving system of a vehicle and various additional systems thereof. Therefore, new designs and technical requirements need to be taken into consideration.

In the case of eco-friendly vehicles using electric motors and batteries as power sources, it is necessary to provide a cooling system configured to perform thermal management on power electronics (PE) devices, high-voltage batteries, motors, and the like. Particularly, since batteries are sensitive to temperature changes, performance and lifespan of the batteries are guaranteed only when the batteries are maintained within a certain temperature range. Accordingly, an efficient thermal management system needs to be provided to ensure optimal performance and longevity of batteries. Due to increasing system requirements for eco-friendly vehicles, a structural configuration of an air-conditioning system in such vehicles has become complicated.

Due to increasing complexity of the air-conditioning system and the thermal management system, a valve system configured to control the air-conditioning system and the thermal management system has also become more sophisticated and multifunctional. In a conventional air-conditioning system having a simple configuration, the flow of air and coolant is controlled using a few valves. Meanwhile, in the case of eco-friendly vehicles, multiple cooling loops are employed to cool batteries and power electronics and to maintain optimal operating temperatures, resulting in increased valve system complexity.

However, due to the increased valve system complexity, interference may occur when the valve system is connected to other fluid system components, which leads to difficulties in the assembly process and increases a manufacturing defect rate. In addition, since connectivity between components becomes more complicated, a manufacturing process becomes more complicated, manufacturing costs increase, and a maintenance process needs to be performed with high accuracy and consistency.

The above information disclosed in this Background section is only to enhance understanding of the background of the disclosure. Therefore, the Background section may contain information that does not form the prior art that is already known to a person of ordinary skill in the art.

### SUMMARY

The present disclosure has been made in an effort to solve the above-described problems associated with the prior art. Aspects of the present disclosure are provide a valve housing and a valve assembly configured to enable an external component and a port to communicate with each other regardless of an actual location of the port, to improve assemblability of the valve housing and the valve assembly, and to increase a degree of freedom of design of the valve housing and the valve assembly.

Other aspects of the present disclosure are to provide a valve housing and a valve assembly capable of reducing manufacturing costs and improving productivity.

Still other aspects of the present disclosure are to provide a valve housing and a valve assembly having a high degree of integration.

The aspects of the present disclosure are not limited to the above-mentioned aspects. Other technical aspects not mentioned herein should be more clearly understood by those having ordinary skill in the art to which the present disclosure pertains from the detailed description of the embodiments.

Other aspects and embodiments of the disclosure are discussed herein.

It should be understood that the terms “vehicle”, “vehicular”, and other similar terms as used herein are inclusive of motor vehicles in general. Such vehicles may encompass passenger automobiles including sport utility vehicles (SUVs), buses, trucks, various commercial vehicles, watercraft including a variety of boats and ships, aircraft, and the like. Such vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed herein.

### BRIEF DESCRIPTION OF THE DRAWINGS

The above and other features of the present disclosure are described in detail with reference to certain example embodiments thereof illustrated in the accompanying drawings, which are given hereinbelow by way of illustration only, and thus are not limitative of the present disclosure, and wherein:

FIG. 1 is an overall perspective view of a valve housing according to an embodiment of the present disclosure;

FIG. 2 is a top perspective view of a housing body and a channel block of a valve housing according to an embodiment of the present disclosure;

FIG. 3 is a rear perspective view of the housing body and the channel block shown in FIG. 2;

FIGS. 4 and 5 are top views of the housing body and the channel block shown in FIG. 2;

FIGS. 6A-6F are views showing fluid movement paths in a valve housing according to an embodiment of the present disclosure;

FIG. 7 is an exploded perspective view of a valve assembly according to an embodiment of the present disclosure;

FIG. 8 is a front perspective view of a hub according to an embodiment of the present disclosure;

FIG. 9 is a rear perspective view of the hub shown in FIG. 8;

FIG. 10 is a view showing the valve assembly shown in FIG. 7;

FIG. 11 is a cross-sectional view of the valve assembly taken along line A-A′ in FIG. 10 and in an assembled state;

FIG. 12 is a cross-sectional view of the valve assembly taken along line B-B′ in FIG. 10 and in an assembled state; and

FIG. 13 is a cross-sectional view of the valve assembly taken along line C-C′ in FIG. 10 and in an assembled state.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, the technical concepts of the present disclosure are described in detail with reference to the accompanying drawings. However, the detailed description discloses and describes example embodiments. The present disclosure is not limited to the specific embodiments described herein. When a component, device, apparatus, valve, body, housing, or the like of the present disclosure is described as having a purpose or performing an operation, function, or the like, the component, device, valve, body, or housing should be considered herein as being “configured to” meet that purpose or to perform that operation or function.

A valve housing 100 and a valve assembly 1000 according to the present disclosure may be applied to vehicles including hybrid electric vehicles, fuel vehicles, and pure electric vehicles. The valve assembly 1000 may be employed as a device or apparatus to deliver or receive fluid (i.e., coolant) to or from an external component and to switch a supply path of the fluid and may be applied to heat exchange fields such as household or industrial applications. Further, the valve assembly may be used in some equipment required for cooling and heating.

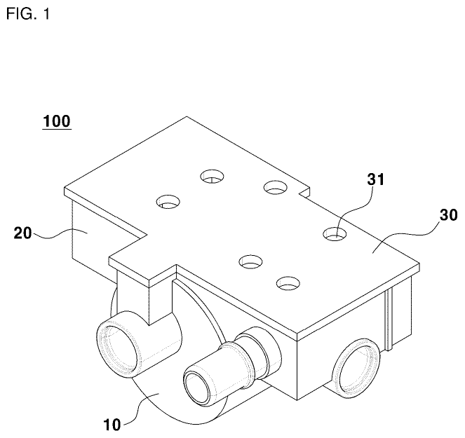

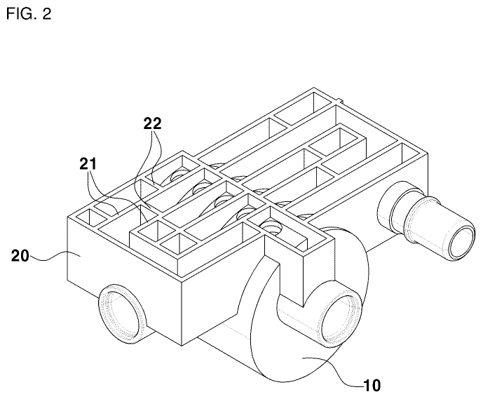

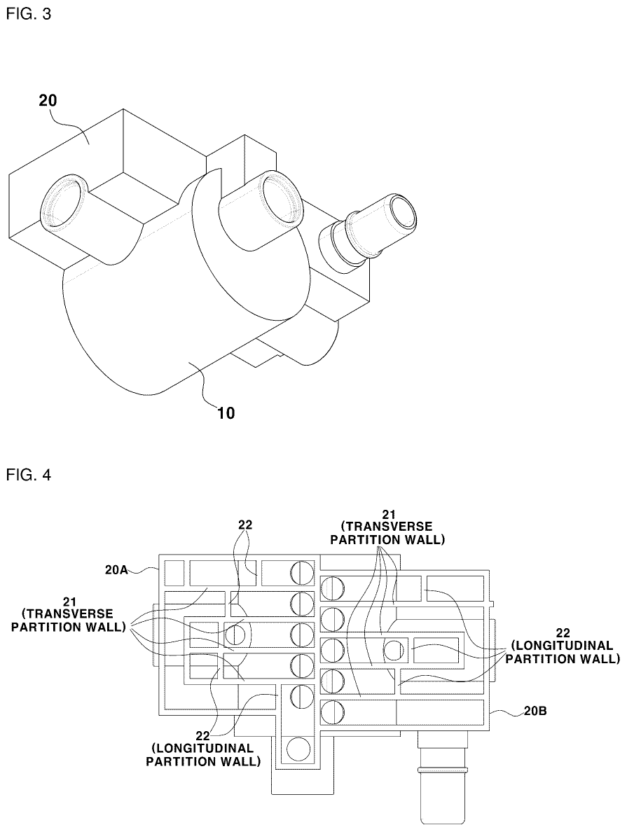

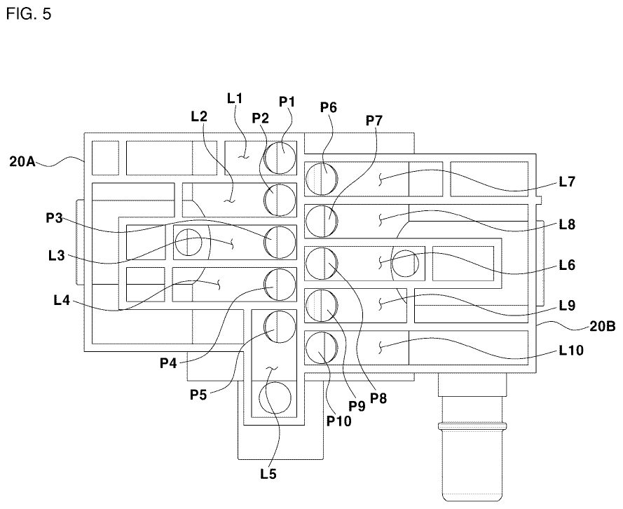

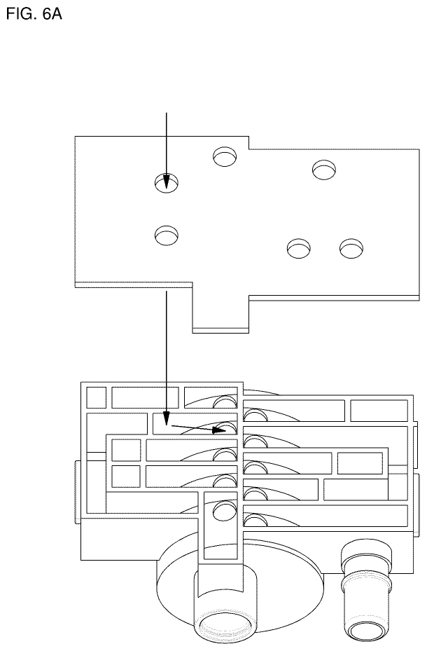

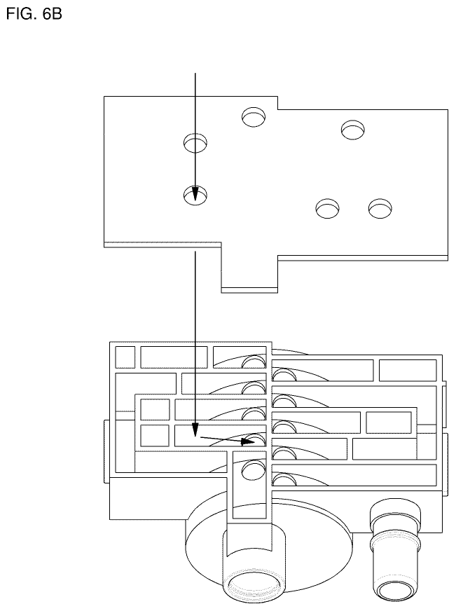

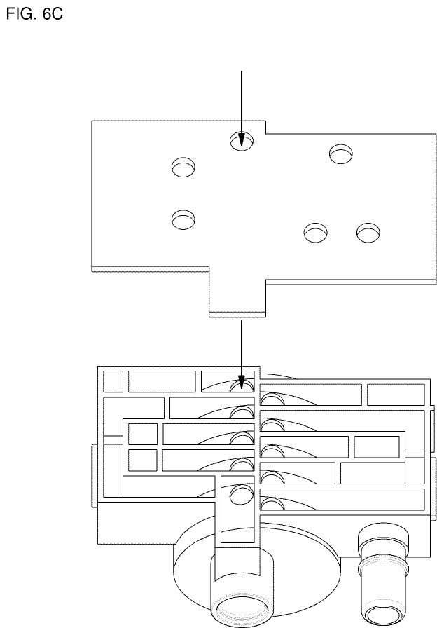

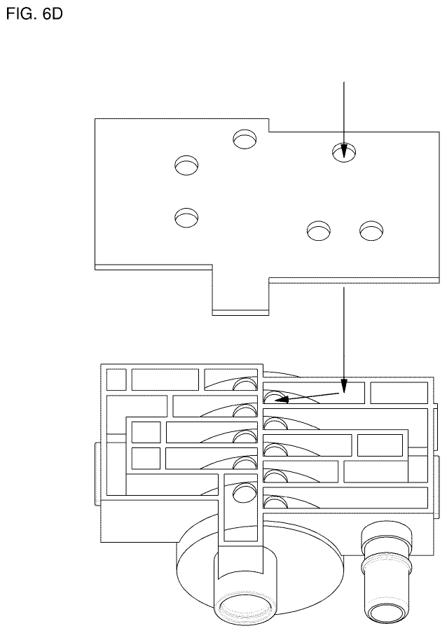

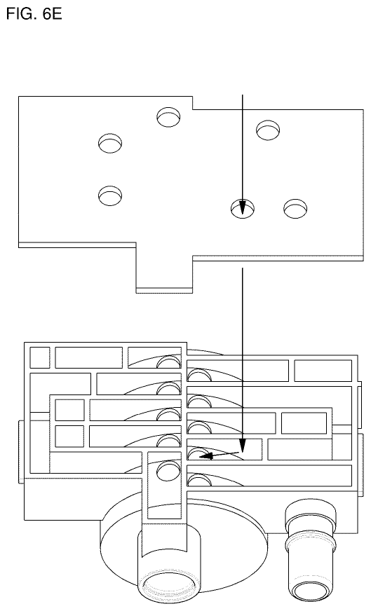

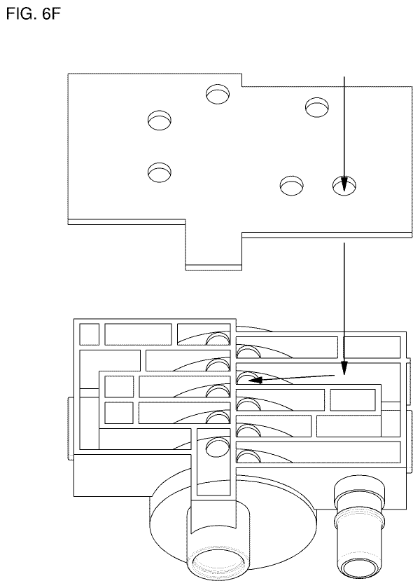

Hereinafter, the valve housing 100 according to an embodiment of the present disclosure is described with reference to FIGS. 1-6F. FIG. 1 is an overall perspective view of the valve housing 100 according to an embodiment of the present disclosure. FIG. 2 is a top perspective view of a housing body and a channel block. FIG. 3 is a rear perspective view of the housing body and the channel block shown in FIG. 2. FIGS. 4 and 5 are top views of the housing body and the channel block shown in FIG. 2. FIGS. 6A-6F are views showing fluid movement paths in the valve housing.

According to an embodiment of the present disclosure, the valve housing 100 may include a housing body 10 configured to accommodate a valve rotor and a channel block 20 having a plurality of channels L1-L10 provided in the inside thereof.

The housing body 10 may include a plurality of ports P1-P10, each disposed or positioned, i.e., formed to communicate with the valve rotor. Further, at least one partition wall is provided in the inside of the housing block 20 to create the plurality of channels. In this embodiment, the at least one partition wall includes at least one transverse partition wall 21 and at least one longitudinal partition wall 22, which may be provided inside the channel block 20 to partition the channel block 20 into the plurality of channels L1-L10. Here, the plurality of channels L1-L10 may be respectively connected to the plurality of ports P1-P10 in a corresponding manner. As used herein, the term “longitudinal” references a direction normal or parallel to the lengthwise orientation or direction of the housing body 10 and the axis of the valve rotor. Also, the term “transverse” references a direction perpendicular to the lengthwise orientation of the housing body 10 and the axis of the valve rotor, as well as the longitudinal direction. However, these terms are used simply for reference to distinguish the various partition walls from one another.

Specifically, the housing body 10 may be formed with the plurality of ports P1-P10 configured to communicate with the valve rotor. The valve rotor may be rotated inside the housing body 10 so as to implement different air-conditioning modes. The valve rotor may be formed in a cylinder shape having a predetermined length, and various air-conditioning modes may be implemented by flow paths formed in the cylindrical valve rotor. Here, the flow paths have distinct patterns at predetermined angles in the circumferential direction.

The housing body 10 may be formed to have a cylindrical shape to accommodate the valve rotor. The channel block 20 may be located on the upper side of the housing body 10. The housing body 10 may have an opening part formed in one side or end thereof, and the valve rotor may be inserted into the housing body 10 through the opening part.

The housing body 10 may be formed with at least one discharge port through which fluid discharged from the valve rotor is discharged. The discharge port may be directly connected to a water pump 70 as described below.

The channel block 20 may be formed to have various shapes. For example, the channel block 20 may be formed to have an approximately rectangular parallelepiped shape. The channel block 20 may be disposed on the upper side of the housing body 10. The longitudinal length or dimension of the channel block 20 may be substantially the same as or similar to the length of the housing body 10. The transverse length or dimension of the channel block 20 may vary depending on the channel length in the channel block 20. The housing body 10 may be disposed in the center of the transverse length of the channel block 20.

The channel block 20 may have an open upper surface, and a guide plate 30, which is described below, may be disposed on the upper surface. At least one transverse partition wall 21 and at least one longitudinal partition wall 22 may be provided inside the channel block 20.

Specifically, at least one longitudinal partition wall 22 disposed in a direction parallel to the longitudinal direction of the housing body 10 and/or at least one transverse partition wall 21 disposed in a direction perpendicular to the longitudinal partition wall 22 may be provided inside the channel block 20. A plurality of channels connected to the respective ports may be partitioned from each other by the transverse partition wall 21 and the longitudinal partition wall 22.

In one embodiment, a plurality of the transverse partition walls 21 may be formed to have different lengths. Since the transverse partition walls 21 are formed to have different lengths, the lengths of the channels partitioned by the transverse partition walls 21 may also be formed to be different from each other.

In one embodiment, a plurality of the longitudinal partition walls 22 may be disposed to cross or bisect two adjacent transverse partition walls 21, and the channels inside the channel block 20 may be formed to be surrounded by a longitudinal partition wall 22 and two transverse partition walls 21 adjacent to the longitudinal partition wall 22. As a result, a plurality of ports and a plurality of channels may communicate with each other in a one-to-one corresponding manner.

According to the present disclosure, the channels connected to the respective ports may extend to desired locations through the channel block 20, thereby enabling external components to communicate with the respective ports regardless of the actual locations of the ports. Such a structural configuration may improve assemblability and may increase a degree of freedom of design. In addition, the degree of freedom of design may be increased by the channels having different lengths.

Meanwhile, as shown in FIG. 2, the upper surface of the channel block 20 may be formed as an opening surface. The guide plate 30 may be disposed on the opening surface of the channel block 20 and may guide fluid to the channels L1-L10 inside the channel block 20.

Specifically, a plurality of through-holes 31 penetrating the guide plate 30 may be formed or provided in the guide plate 30. Fluids discharged from different components may be introduced into the respective through-holes 31, and each of the through-holes 31 may communicate with a corresponding one of the plurality of channels inside the channel block 20.

Fluid having passed through a through-hole 31 may flow through a channel connected to the through-hole 31. Thereafter, the fluid may be introduced into the valve rotor through a port communicating with the channel. FIGS. 6A-6F are views showing an example of flow paths of fluid introduced into each through-hole 31. As shown in FIGS. 6A-6F, fluid introduced into each through-hole 31 may flow through a specific channel connected to the through-hole 31 and then may flow into the valve rotor through a port formed in the housing body 10.

The housing body 10 and the channel block 20 may be formed to be integrated with each other. The housing body 10 and the channel block 20 may be formed as one continuous, i.e., contiguous or monolithic structure during the manufacturing process without a separate assembly process. For example, the housing body 10 and the channel block 20 may be formed to be integrated with each other through injection molding, 3D printing, or the like.

In one embodiment, the housing body 10 and the channel block 20 may be formed to be integrated with each other through injection molding. The housing body 10 and the channel block 20 may be integrally injection-molded as one monolithic structure or part to simplify a manufacturing process. In this manner, additional processes are not required for bonding and sealing, and manufacturing costs are reduced. In addition, the channel block 20 does not have a complex structure other than the transverse and longitudinal partition walls. Accordingly, even if the housing body 10 and the channel block 20 are simultaneously injection-molded, a mold for the housing body 10 and the channel block 20 does not become significantly complicated.

In one embodiment, the guide plate 30 may be part of the contiguous or monolithic structure by being injection-molded integrally with the housing body 10 and the channel block 20 or may be fused and bonded to the upper surface of the channel block 20. Accordingly, airtightness between the guide plate 30 and the channel block 20 may be secured, and manufacturing costs may be reduced because a separate member (i.e., a gasket) is not required for airtightness.

In one embodiment, a plurality of ports positioned or disposed, i.e., formed or provided in the housing body 10 may be formed along a first column and a second column. First ports formed in the first column may be referred to as a first port group P1-P5, and second ports formed in the second column may be referred to as a second port group P6-P10. In this case, the first ports of the first port group and the second ports of the second port group may be disposed alternately in a zigzag configuration with a predetermined interval between the first and second port groups. As described above, the plurality of ports is formed along two columns, and the first ports formed along the first column and the second ports formed along the second column are disposed alternately in a zigzag arrangement, thereby optimizing the valve size.

Here, the channel block 20 may include a first channel block 20A including a plurality of first channels L1-L5 connected to the respective first ports P1-P5 of the first port group. Also, the channel block 20 may include a second channel block 20B including a plurality of second channels L6-L10 connected to the respective second ports P6-P10 of the second port group.

At least one transverse partition wall 21 and at least one longitudinal partition wall 22 may be provided inside the first channel block 20A and the second channel block 20B. The partition walls 21 and 22 disposed inside the channel block may individually partition the inside of the channel block to form a plurality of channels.

As shown in FIG. 5, as an example, five first channels L1-L5 are formed inside the first channel block 20A, and five second channels L6-L10 are formed inside the second channel block 20B. The number of channels formed in each channel block may be appropriately designed and changed depending on the number of ports formed in the first and second columns.

The first channel block 20A may be formed or provided to protrude from the center of the housing body 10 in a first direction (a left direction in FIG. 5). The second channel block 20B may be formed or provided to protrude from the center of the housing body 10 in a second direction (a right direction in FIG. 5). The first direction and the second direction may be opposite to each other.

Since the channels connected to the first port group and the channels connected to the second port group are formed in separate channel blocks, interference between external components connected to the first port group and external components connected to the second port group may be reduced, and a degree of freedom of design may be improved.

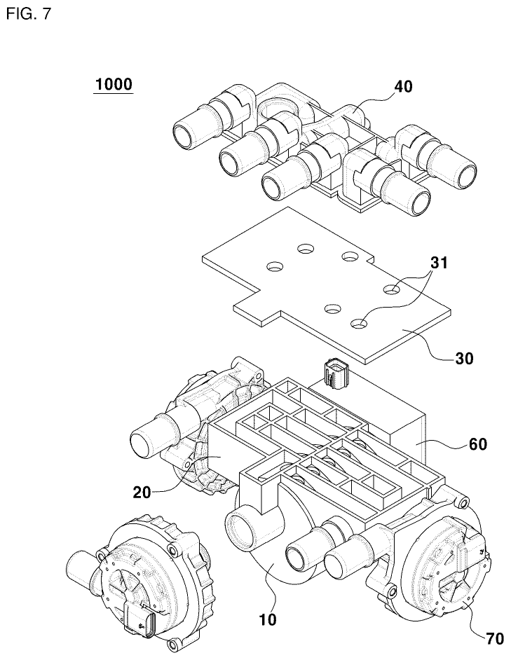

The valve housing 100 has been described above, and the valve assembly 1000 according to an embodiment of the present disclosure is described below. The above-described configuration of the housing body 10, the channel block 20, and/or the guide plate 30 may also be applied to the valve assembly 1000 described below, and each configuration is described below with reference to FIGS. 7-13.

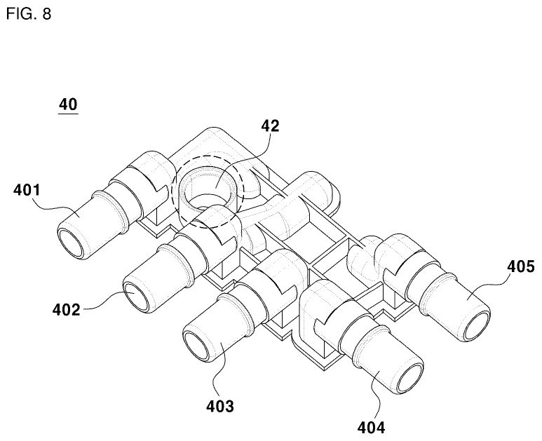

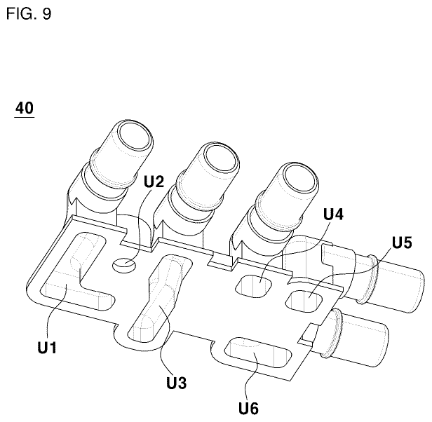

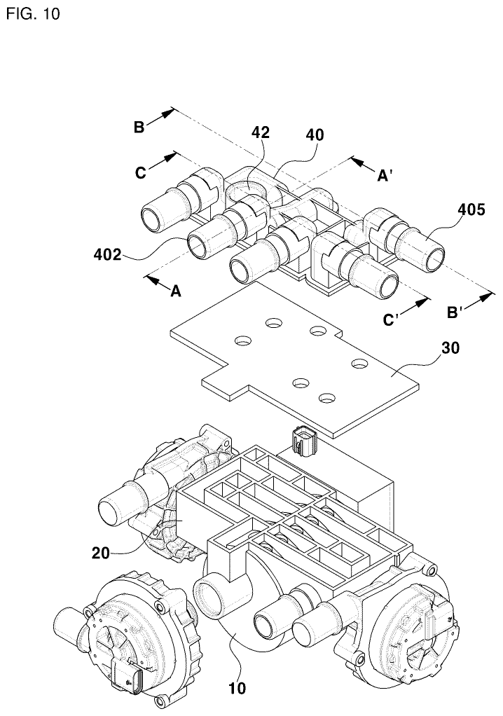

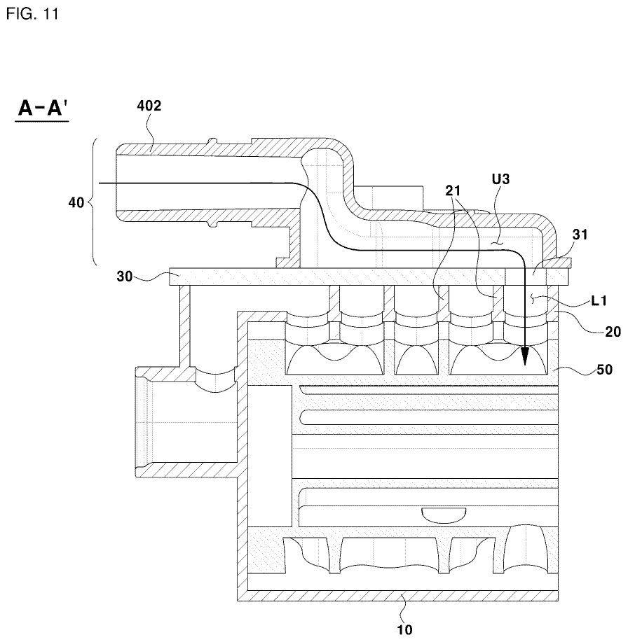

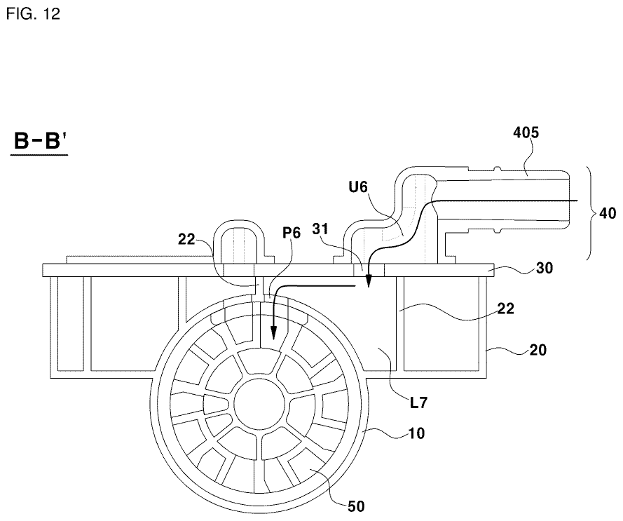

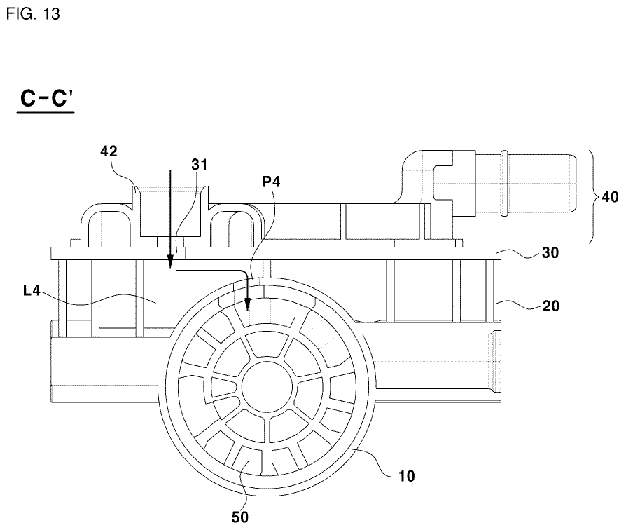

FIG. 7 is an exploded perspective view of the valve assembly 1000 according to an embodiment of the present disclosure. FIG. 8 is a front perspective view of a hub according to an embodiment of the present disclosure. FIG. 9 is a rear perspective view of the hub shown in FIG. 8. FIG. 10 is another exploded view of the valve assembly shown in FIG. 7. FIG. 11 is a cross-sectional view taken along line A-A′ in FIG. 10, but in an assembled state. FIG. 12 is a cross-sectional view taken along line B-B′ in FIG. 10, but in an assembled state. FIG. 13 is a cross-sectional view taken along line C-C′ in FIG. 10, but in an assembled state. In FIG. 10, the water pump 70 is omitted.

The valve assembly 1000 according to an embodiment of the present disclosure includes the housing body 10 configured to accommodate a valve rotor 50. The valve assembly 1000 also includes the channel block 20 having a plurality of channels provided in the inside thereof, a hub 40 stacked on the upper side of the channel block 20 and configured to enable at least one external component to communicate with the channel block 20, and the guide plate 30 interposed between the channel block 20 and the hub 40. The valve rotor 50 may be rotated in the housing body 10 by an actuator 60 and may adjust the flow direction of fluid.

The housing body 10 may have at least one discharge port formed in one side thereof and configured to discharge fluid discharged from the valve rotor. The discharge port may be formed in a horizontal direction and may be directly connected to the water pump 70. Accordingly, the water pump 70 is disposed such that the height of the water pump 70 is the same as or similar to the height of the housing body 10, and the hub 40 is disposed on the upper side of the housing body 10 and the channel block 20. In this manner, the valve assembly 1000 according to the present disclosure is not formed to have a large size in the horizontal direction or the vertical direction but is formed to have a predetermined area in the horizontal direction and a predetermined height in the height direction. Accordingly, it is possible to provide a valve assembly having a high degree of integration.

Meanwhile, a plurality of hub channels U1-U6 may be provided along the hub 40 and may be located on the upper side of the guide plate 30. A plurality of channels L1-L10 may be provided along the channel block 20 and may be located on the lower side of the guide plate 30. Hereinafter, in order to distinguish between the channels L1-L10 provided along the channel block 20 and the hub channels U1-U6, the channels L1-L10 provided along the channel block 20 are referred to as housing channels.

According to the present disclosure, a double-layered flow path may be formed by providing a hub channel on the upper side of the guide plate and a housing channel on the lower side of the guide plate.

The guide plate 30 may be formed with a plurality of through-holes 31 penetrating the guide plate 30. Each of the through-holes 31 may allow one of the plurality of hub channels U1-U6 to communicate with one of the housing channels L1-L10. Accordingly, the fluid may sequentially flow through the hub channels, the through-holes, and the housing channels (or in the reverse direction).

In other words, the hub channels and the housing channels are structurally configured to be connected to each other through the through-holes interposed therebetween, thereby effectively implementing a complex flow path. Simultaneously, each structure of the hub 40 and the channel block 20 is simplified to achieve improvement in manufacturing convenience.

The hub 40 may include a plurality of connecting parts 401-405 connected to external components (i.e., heat exchangers). The hub channels may each be formed to extend from one connecting part to one through-hole 31.

Each of the connecting parts 401-405 may be selectively formed or provided in any one of a forward, rearward, leftward, or rightward direction. An external component may be disposed at a desired location to form an interface between the connecting part and a peripheral component. In this manner, a degree of freedom of connectivity between the valve assembly 1000 and external components may be improved, and high assemblability may be achieved.

The hub channels U1-U6 may include a vertical channel that is vertically formed extending from the upper portion to the lower portion of the hub 40 and/or a horizontal channel that is formed to be horizontal with the upper surface of the guide plate 30. The horizontal channel of the hub channels may allow the hub channel to communicate with the desired through-hole 31. Further, in the case of a connecting part adjacent to the through-hole 31, the connecting part may be vertically connected to the through-hole 31 through the vertical channel to implement communication between the connecting part and the through-hole 31.

At least one partition wall may be provided inside the channel block 20 to partition the channel block into a plurality of housing channels L1-L10.

In one embodiment, at least one transverse partition wall 21 and/or at least one longitudinal partition wall 22 may be provided inside the channel block 20. The channel block 20 may be partitioned into a plurality of housing channels L1-L10 by transverse partition walls 21 and longitudinal partition walls 22. A plurality of housing channels L1-L10 may be connected to a plurality of ports P1-P10 formed in the housing body 10, respectively.

The housing body 10 and the channel block 20 may be formed to be integrated with each other. The housing body 10 and the channel block 20 may be formed as one continuous, i.e., contiguous or monolithic structure during the manufacturing process without a separate assembly process. For example, the housing body 10 and the channel block 20 may be formed to be integrated with each other through injection molding, 3D printing, or the like.

In one embodiment, the housing body 10 and the channel block 20 may be integrally injection-molded. Here, the channel block 20 and the guide plate 30 may be fused and coupled to each other, or the guide plate 30 and the hub 40 may be fused and coupled to each other. For example, fusion may correspond to a thermal fusion method or a laser fusion method.

In this manner, airtightness between the guide plate 30 and the channel block 20 may be secured, and manufacturing costs may be reduced because a separate member (i.e., a gasket) is not required for airtightness.

Hereinafter, the flow of fluid in the valve assembly is described with reference to FIGS. 11 and 12.

As shown in FIG. 11, fluid introduced through the connecting part 402 may flow along the hub channel U3 formed between the upper surface of the guide plate 30 and the hub 40. The fluid may flow along the hub channel U3 and may pass through a through-hole 31 in the guide plate 30. Thereafter, the fluid may be introduced into the housing channel L1 located on the lower side of the guide plate 30 and formed in the channel block 20. The fluid flowing through the housing channel L1 may be introduced into the valve rotor 50 through a port formed in the housing body 10, and the discharge direction of the fluid may be determined by the valve rotor 50. The housing channel L1 may be partitioned by a transverse partition wall 21.

As shown in FIG. 12, fluid introduced through the connecting part 405 may flow along the hub channel U6 formed between the upper surface of the guide plate 30 and the hub 40. The fluid may flow along the hub channel U6 and may pass through a through-hole 31 in the guide plate 30. Thereafter, the fluid may be introduced into the housing channel L7 located on the lower side of the guide plate 30 and formed in the channel block 20. The fluid flowing through the housing channel L7 may be introduced into the valve rotor 50 through a port formed in the housing body 10, and the discharge direction of the fluid may be determined by the valve rotor 50. The housing channel L7 may be partitioned by a longitudinal partition wall 22.

The following description is given with reference to FIG. 13.

According to one embodiment of the present disclosure, a flange 42 may be formed on the upper surface of the hub 40 in the vertical direction. A reservoir tank to store fluid may be assembled with the flange 42, and fluid discharged from the reservoir tank may be introduced into the valve assembly through the flange 42.

At least one of the plurality of through-holes 31 is formed at a position vertically aligned with the flange 42, so that the fluid discharged from the reservoir tank may flow vertically from the flange 42 and may be introduced into the housing channel L4. The fluid introduced into the housing channel L4 may flow along the housing channel L4 and may be introduced into the valve rotor 50 through a port communicating with the housing channel L4. As described above, the fluid flows vertically from the hub and the guide plate and then flows into the housing channel L4, thereby preventing bubbles from being mixed in the fluid.

As should be apparent from the above description, the present disclosure provides a valve housing and a valve assembly capable of improving assemblability and increasing a degree of freedom of design.

Additionally, it is possible to improve productivity of the valve housing and the valve assembly and to reduce manufacturing costs thereof.

The effects of the present disclosure are not limited to the above-mentioned effects. Other effects not mentioned herein should be more clearly understood by those of ordinary skill in the art to which the present disclosure pertains from the detailed description of the embodiments and the accompanying drawings.

Although the present disclosure has been described in detail with reference to various embodiments thereof, the scope of the present disclosure is not limited to the above-described embodiments and the accompanying drawings. It should be appreciated by those of ordinary skill in the art to which the present disclosure pertains that various modifications and improvements may be made in the embodiments without changing the technical idea or essential features of the disclosure. Therefore, it should be understood that the above-described embodiments are illustrative in all respects and are not restrictive.

What is claimed is:

1. A valve housing comprising:
a housing body configured to accommodate a valve rotor;
a channel block;
a plurality of channels provided in an inside of the channel block;
a plurality of ports provided in the housing body; and
at least one partition wall provided in the inside of the channel block, the at least one partition wall partitioning the channel block into the plurality of channels,
wherein the plurality of channels are respectively connected to the plurality of ports.

2. The valve housing of claim 1, wherein:
the channel block has an open upper surface; and
the valve housing further comprises a guide plate disposed on the upper surface of the channel block and configured to guide fluid into the channels.

3. The valve housing of claim 2, wherein
the guide plate has a plurality of through-holes each penetrating the guide plate, and
the plurality of through-holes each communicate with a respective one of the plurality of channels.

4. The valve housing of claim 2, wherein the guide plate is integrally formed as a monolithic part of the housing body and the channel block via injection molding or is fused and bonded to the upper surface of the channel block.

5. The valve housing of claim 1, wherein the housing body is integrated with the channel block.

6. The valve housing of claim 5, wherein the housing body and the channel block are integrally formed as a monolithic structure via injection molding.

7. The valve housing of claim 1, wherein the at least one partition wall is a transverse partition wall or a longitudinal partition wall provided in the inside thereof.

8. The valve housing of claim 1, wherein the at least one partition wall comprises at least transverse partition walls configured such that lengths of the plurality of channels are different from each other.

9. The valve housing of claim 8, wherein:
a longitudinal partition wall is disposed to cross a space between two of the transverse partition walls adjacent to the longitudinal partition wall; and
one of the plurality of channels is surrounded by the longitudinal partition wall and the two transverse partition walls crossed by the longitudinal partition wall.

10. The valve housing of claim 1, wherein:
the plurality of ports are formed along a first column and a second column; and
based on first ports of the plurality of ports in the first column being a first port group and based on second ports of the plurality of ports in the second column being a second port group, the first ports in the first port group and the second ports in the second port group are disposed alternately with a predetermined interval between the first and second port groups.

11. The valve housing of claim 10, wherein:
the channel block comprises
a first channel block including first channels of the plurality of channels connected to the first respective ports in the first port group, and
a second channel block including second channels of the plurality of channels connected to the respective second ports in the second port group; and
at least one partition wall is provided inside each of the first channel block and the second channel block such that the first channel block and the second channel block are partitioned into the first and second channels, respectively, by the at least one partition walls.

12. The valve housing of claim 11, wherein:
the first channel block protrudes from a central portion of the housing body in a first direction;
the second channel block protrudes from the central portion of the housing body in a second direction; and
the first direction and the second direction are opposite to each other.

13. A valve housing comprising:
a housing body configured to accommodate a valve rotor;
a channel block having a plurality of housing channels provided in an inside thereof;
a hub stacked on an upper side of the channel block, the hub configured to allow at least one external component to communicate with the channel block; and
a guide plate interposed between the channel block and the hub,
wherein a plurality of hub channels is provided along the hub and is located on an upper side of the guide plate, and
wherein a plurality of housing channels is provided along the channel block and is located on a lower side of the guide plate.

14. The valve housing of claim 13, wherein:
the guide plate has a plurality of through-holes each penetrating the guide plate; and
each of the through-holes allows any one of the plurality of hub channels to communicate with any one of the plurality of housing channels.

15. The valve housing of claim 14, wherein:
the hub comprises a plurality of connecting parts configured to be connected to external components; and
the hub channels are formed to extend from the connecting parts to the through-holes.

16. The valve housing of claim 14, wherein:
the hub has a flange formed on an upper surface thereof in a vertical direction and
at least one of the through-holes is formed at a position vertically aligned with the flange such that fluid can flow vertically from the flange and into one of the plurality of housing channels.

17. The valve housing of claim 13, wherein:
at least one partition wall is provided inside the channel block to partition the channel block into the plurality of housing channels; and
the plurality of housing channels is respectively connected to a plurality of ports.

18. The valve housing of claim 13, wherein the housing body and the channel block are integrated with each other.

19. The valve housing of claim 18, wherein:
the housing body and the channel block are integrally injection-molded as a monolithic structure; and
the channel block and the guide plate are fused and bonded to each other, or the guide plate and the hub are fused and bonded to each other.

20. A valve assembly comprising:
the valve housing of claim 13; and
a valve rotor in the housing body of the valve housing.
